(19) United States
(12) Patent Application Publication
(10) Pub. No.: US 2011/0203548 A1
(43) Pub. Date: Aug. 25, 2011

(54) Plunger Motor

(76) Inventor: Thomas L. Fillios, Boston, MA (US)

(21) Appl. No.: 13/034,626

(22) Filed: Feb. 24, 2011

Related U.S. Application Data
(60) Provisional application No. 61/307,448, filed on Feb. 24, 2010.

(51) Int. Cl. F02B 53/00

(52) U.S. Cl. 123/241

(57) ABSTRACT

An oilless motor wherein the device is round 11″ in diameter and 5″ long motor. The heads are at each end, which are the same. The heads are identical. There is a piston that goes back and forth inside the 11″ diameter motor. Made of the same material as the piston and embedded in the middle of the piston and perturbing 8″ both ways, the piston being in the middle. This 1″ in diameter goes through the middle of both of both heads at both ends. This rod is guided by bearings at both ends. When the piston goes up to the bottom of the cylinder head a firing or exhaust occurs, then the plunger piston goes to the opposite cylinder head.

### FIELD OF THE INVENTION

The present invention relates generally to fossil fuel engines and more particularly to an engine that operates without the need for continual oil lubrication.

### BACKGROUND OF THE INVENTION

This invention improves or replaces many motors. This is a natural for hydraulic or air motors, cars trucks motor cycles. Can be used in airplanes with hydraulics to rotate on propellers an airplane, sand and snow machines, and no oil in this motor.

The present invention generally relates an oilless gas engines, and, more specifically, to oilless rotors supported by several non-contact bearings used in combination with each other.

Conventional automobile gas engines use a complex oil lubrication system to lubricate rolling element bearings supporting the high-speed shafting. Controls and accessories that support critical engine operation, such as the fuel and lubrication systems, cannot operate at the high shaft speeds and, therefore, must be geared down using complex mechanical gear trains. These conventional engine configurations are complex and result in high initial as well as high operational costs.

U.S. Pat. No. 6,367,241 concerns a pressure-assisted electromagnetic thrust bearing. The pressure-assisted electromagnetic thrust bearing is a hydrostatic bearing using compressor discharge air. The air is hot and, although some cooling may take place in the tube 70, the air increases the magnetic bearing operating temperatures, reducing its life and reliability. The compressor air is piped into air chambers 90 and, due to seal leakage; some of this compressed air may result in a loss to the engine thermodynamic performance. The pressure at altitude will be lower, thus reducing the thrust load reaction capability in the pressure-assisted fluid bearing (FIG. 2 of U.S. Pat. No. 6,367,241).

As can be seen, there is a need for a gas engine having bearings that are simple in design, relatively small in size, and light in weight. Moreover, such a gas engine will not require rings, pushrods, rockers, camshafts or related valves.

### SUMMARY OF THE INVENTION

This invention is a round 11″ in diameter and 5″ long motor. The heads are at each end, which are the same. The heads are identical. There is a piston that goes back and forth inside the 11″ diameter motor. Made of the same material as the piston and embedded in the middle of the piston and perturbing 8″ both ways, the piston being in the middle. This 1″ in diameter goes through the middle of both of both heads at both ends. This rod is guided by bearings at both ends. When the piston goes up to the bottom of the cylinder head a firing or exhaust occurs, then the plunger piston goes to the opposite cylinder head. The same thing occurs, the cylinder head either fires the combustion centers off or exhaust occurs then the plunger piston goes back and forth. At the cylinder head is a ball valve that turns 90 degrees to fire or exhaust in the cylinder head are 4 direct fuel injectors, 4 direct air injectors and a method to spark off the combustion. Also on the top of the cylinder head is a 1′ diameter coolant either in flow or out exhaust, also is 4 1″ in diameter exhaust ports. The screws in bearings are at the top center head circling the plunger rod. These bearings hold up straight and lube the rod. There is no oil in this motor at all. The plunger piston does not touch the cylinder walls. No rings, pushrods, rockers, camshafts, hydraulic oil pistons, and no many bolts and washers. Also no valves.

It is therefore one object of this invention to provide an oilless engine.

It is another object of this invention to provide an engine that does not require valves, rings or rockers.

It is still another object of this invention to provide a novel engine to operate in conjunction with another hydraulic device.

### BRIEF DESCRIPTION OF THE DRAWINGS

Detailed Description of the Drawings

What is claimed is:

1. A plunger motor, which operates without the use of valves, rings, rockers or camshaft and by which oil is not used within the combustion chamber, comprised of double sided pistons turned up at each end.

2. A plunger motor of claim 1 wherein; electric or hydraulic motors can be mounted at both ends.

3. A plunger motor of claim 1 wherein side cylinder exhaust is used.

4. A plunger motor of claim 1 wherein the cylinder head locks into the plunger motor.

5. A plunger motor of claim 1 wherein combustion occurs at both ends of the cylinder.

6. A plunger motor of claim 1 wherein multiple combustion areas are possible.
